(19) United States
(12) Patent Application Publication
(10) Pub. No.: US 2006/0050731 A1
(43) Pub. Date: Mar. 9, 2006

(54) High-speed IEEE 1394 link interface

(76) Inventor: Christopher Thomas, San Diego, CA (US)

Correspondence Address: Karl M. Steins;Steins & Associates, Suite 120, 2333 Camino del Rio South, San Diego, CA, 92108, US

(21) Appl. No.: 11/222,703

(22) Filed: Sep. 9, 2005

Related U.S. Application Data
(60) Provisional application No. 60/608,207, filed on Sep. 9, 2004.

(51) Int. Cl. H04J 3/02

(52) U.S. Cl. 370/462; 370/463

(57) ABSTRACT

A High-speed IEEE 1394 Link Interface is disclosed. Also disclosed is an interface device and method that is compatible with legacy IEEE 1394 devices. The device is used to replace a conventional 1394 physical layer interface device and can then cooperatively operate with a slightly modified link layer controller. The device is further selectively activatable and deactivatable. When activated, the device will double the clock speed, and therefore permit data transfer rates of 1600 Megabits per second, with Control Signal transfer speeds of 200 MHz.

This invention claims priority from, and is filed within one year of, Provisional Application Ser. No. 60/608,207, filed Sep. 9, 2004.

### BACKGROUND OF THE INVENTION

1. Field of the Invention

This invention relates generally to IEEE 1394 communications systems and, more specifically, to a High-speed IEEE 1394 Link Interface.

2. Description of Related Art

A key technology for digital traffic, and in particular, high-speed communications with remote devices such as digital TV's, external hard drives, printers and other devices is the IEEE 1394 multimedia bus. Also known as “firewire” in the United States, this bus and associated protocol was developed to be “plug and play” and to efficiently handle the movement of data while connected systems are busy with other tasks or applications.

In defining the IEEE 1394 protocol, one must first understand the environment that is defined by the protocol; this can be best understood by consideration of FIG. 1. FIG. 1 is a diagram 10 depicting the conventional layers defined by IEEE 1394 communications protocol. Four layers are defined by the protocol: the mechanical physical layer, within which cables 11 and connectors 12 are found; the electrical physical layer, within which signaling specifications and networking rules are defined or implemented, and where A-mode or B-mode “Phy” devices 14 are found; the link layer, wherein transferred data is manipulated or formatted, and where Link Layer Controller (“Link”) devices 16 are found; and the protocol/application layer, wherein the applications or protocols 18 generating or using the transported data are found.

While the IEEE 1394 standard does include expansion into ultra-high-speed communications, it is currently only commercially viable in two modes: 1394A or 1394B. 1394A is for a 400 MBS data transfer rate and 1394B is for an 800 NBS serial bus speed (between the Phy and Link layers). The pertinent portions of the operation of these two protocols is discussed in connection with FIG. 2.

Prior Art Operational Sequence

Generally, when the Phy is powered up and RSTB is released, the LLC is activated with the LKON signal and PCLK begins toggling. The Link then configures the Phy for operation by programming the Phy's internal registers. Finally, standard register settings such as Contender may be set as needed. After configuration, the LLC resets the Phy and the Phy begins operation with the new parameters. When a cable is connected, the Phy automatically detects the format and speed of the remote device and activates the port. The Phy then notifies the Link of bus activity, and the Link may request the bus for data transmission.

Serial bus activity begins with a discovery protocol. Discovery protocol is biased towards producing Beta Mode (8B/10B) connections over Legacy Mode (Data/Strobe) connections. The discovery protocol begins by sending bursts of tones over the serial cable, while at the same time listening for tones from a remote device. When tones are detected from the remote device, the two devices trade speed capability information and negotiate an operating speed for the connection. After the devices agree on an operating speed, both devices start transmitting symbols at this speed.

If no tones are detected for a period of time, the Phy will check for the existence of TpBias or connect_detect, indicating that the other device is operating in Legacy Mode. If TpBias or connect_detect is detected, the Phy will wait another period of time and try toning again in case the remote device is capable of Beta Mode operation. If toning is now detected, the above speed negotiation occurs. Otherwise, the connection is started in Legacy Mode with both devices transmitting IDLE.

If no tones are detected and both TpBias and connect_detect are false, the Phy will set its own TpBias to try to wake up the remote device that is listening for Legacy Mode devices. If TpBias is now detected, the Phy will again try toning in case the remote device is capable of Beta Mode operation. If toning is detected, the above speed negotiation occurs. Otherwise, the connection is started in Legacy Mode with both devices transmitting IDLE. If TpBias is not detected from the remote device after the local Phy has generated TpBias, then the discovery procedure begins again with toning and will continue looping through toning, bias/connect detection, and bias generation until a connection is established.

If a Beta Mode connection has been established, both devices begin transmitting training symbols to synchronize clock-and-data recovery circuits, data scramblers, and 8B/10B running sums. After all circuits have been synchronized, the devices begin a loop-test procedure intended to prevent loops in the bus architecture. Before a port on a device is activated, a check is run to see if activation would result in a loop. If so, the port is disabled so that correct bus operation can begin. Otherwise, the devices are ready to begin with a Bus Reset. If a Legacy Mode connection has been established, Bus Reset begins immediately.

Bus Reset symbols are transmitted continuously for a period of time long enough for all connected devices to be able to detect it, no matter what state they may be in. When the Bus Reset period is complete, the devices begin Tree Identification, where the hierarchy of the serial bus is established. Each device notifies its connected peers that they are its “parents”, or higher-level nodes in the tree. Each port on a device that receives a notification that it is a parent sends its respective peer port a notification that it is a “child”, or lower-level node. This is considered a handshake, and it indicates that the tree identification between these two devices is complete. If two devices simultaneously notify each other that they are parents, then they will back off a period of time to resolve the conflict. After all ports on all devices have gone through the handshake procedure, then tree identification for the bus is complete and one device is left with all active ports identified as children. This device is referred to as the root node. All devices then begin the self-identification phase of startup, where they transmit information about themselves and are assigned a physical address on the bus. Before transmitting this information, each device requests permission to transmit, and these requests are passed to the parent port and towards the root node. The root node chooses a request from its children and grants that node permission to transmit. If the node that receives the grant has children that are requesting the bus, then the grant is passed on to them. This continues until a leaf node (a node with only one connection, to its parent), receives a grant, at which time it sends packets containing its identification information. This information is repeated up and down the bus such that every device sees all packets that are transmitted. After the transmitting node ends its transmission, it transitions into an IDLE state, where it is no longer requesting the bus and is simply waiting to receive packets and for the self-identification phase to complete. The parent of a node that completes its self identification transmit sequence then grants any other child port that is requesting the bus. After all of its children have completed their self identification sequence, then that device is able to transmit its own sequence, followed by a transition into IDLE. This pattern is repeated by every device until all devices have sent their self-identification information, with the last device being the root node. All devices are now in the IDLE state and ready to receive or transmit normal packets on the bus.

Before a device may transmit onto the bus, it must first arbitrate for control of the bus. Control of the arbitration of the bus differs between clouds of Legacy Mode devices and Beta Mode devices, but both have the concept of two separate intervals, the Isochronous Interval and the Asynchronous Interval. Packets to be transmitted are classified as either Isochronous or Asynchronous depending on the type of data that is carried, and these packets are only allowed during their respective intervals. Isochronous packets are given priority over Asynchronous packets, as their data is time-bounded. All requests to transmit isochronous data are honored before any requests to transmit asynchronous data. After all isochronous requests are completed, asynchronous requests are serviced until the start of the next isochronous interval begins. The beginning of the isochronous interval is called the Cycle Start, and occurs every 150 ms.

Beta Mode devices use the new BOSS arbitration, where the node that is currently transmitting on the serial bus determines which of its child nodes (or its own link) has the best outstanding request, and then grants that node after it is done its own transmission. If none of its child nodes have valid requests for the current interval, then it passes the grant on to its parent port, which in turn checks the requests of its child ports. This continues until the final node to receive the grant is the root node, which can then determine a grant to give to any node. Nodes that are not the current BOSS pass requests from their children (as well as their own link) up to the parent and towards the root, so that the root always has visibility to the best requests on the bus.

Legacy Mode devices do not use BOSS arbitration. Instead, these devices always pass requests to their parents and toward the root node. The root node always decides which of its child ports should be granted.

When new devices are introduced into an existing bus, a reset is initiated on that bus and all nodes begin the Bus Reset->Tree ID->Self ID startup sequence again. This allows the bus architecture to develop again, and potentially a new root node to be chosen.

Active devices that are not being used may enter one of several inactive states to save power: Disabled state, in which the devices to not maintain any connectivity to each other and must begin the discovery procedure to become active again; Suspended state, where devices maintain connectivity but not physical bus information, and therefore must go through Bus Reset->Tree ID->Self ID; and Standby State, available only to Beta Mode devices, where devices maintain both connectivity and physical bus information, and may be returned to active states with minimal bus interruption.

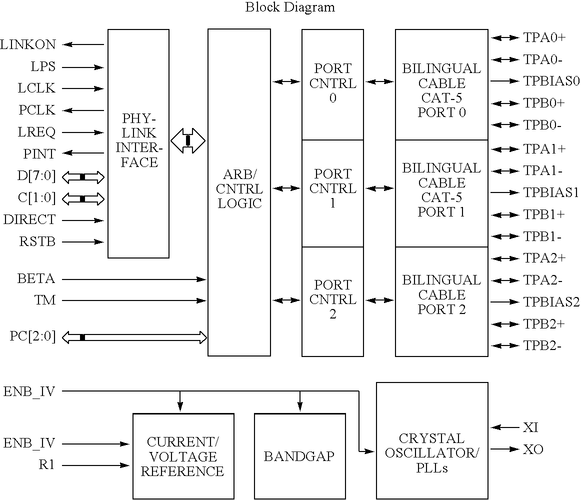

Turning to FIG. 2, we can summarize the pertinent operational sequence for the prior art systems to make the distinctions from the present invention more clear. FIG. 2 are flow charts depicting the conventional IEEE 1394A and IEEE 1394B Phy-Link Interface operation, 20 and 22 respectively. If the BMODE_LINK is set to low 100, when the Phy is powered up 102, and after the Link programs the Phy's internal registers 104, an A or Alpha Phy-Link Interface will be enabled (IEEE 1394A) 106. The pertinent characteristics of the 1394A Phy-Link Interface is that the Clock speed is 50 MHz, the Data transfer rate is 400 Megabits per second, and the Control Signal Transfer speed is also 50 MHz.

If the BMODE_LINK is set to high 108, when the Phy is powered up 110, and after the Link programs the Phy's internal registers 112, a B or Beta Phy-Link Interface will be enabled (EEE 1394B) 114. The pertinent characteristics of the 1394B Phy-Link Interface is that the Clock speed is 100 MHz, the Data transfer rate is 800 Megabits per second, and the Control Signal Transfer speed is also 100 MHz.

Until the advent of the present invention, then, there was no way of exceeding a Phy-Link Interface data transfer rate of 800 MBS using widely-used IEEE 1394B architecture.

### SUMMARY OF THE INVENTION

In light of the aforementioned problems associated with the prior devices and methods, it is an object of the present invention to provide a High-speed IEEE 1394 Link Interface. The interface device and method should be compatible with legacy IEEE 1394 devices. The device should replace a conventional 1394 physical layer interface device and should cooperatively operate with a slightly modified link layer controller. The device should further be selectively activatable and deactivatable. When activated, the device should double the clock speed, and therefore permit data transfer rates of 1600 Megabits per second, with Control Signal transfer speeds of 200 MHz.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a diagram depicting the conventional layers defined by IEEE 1394 communications protocol;

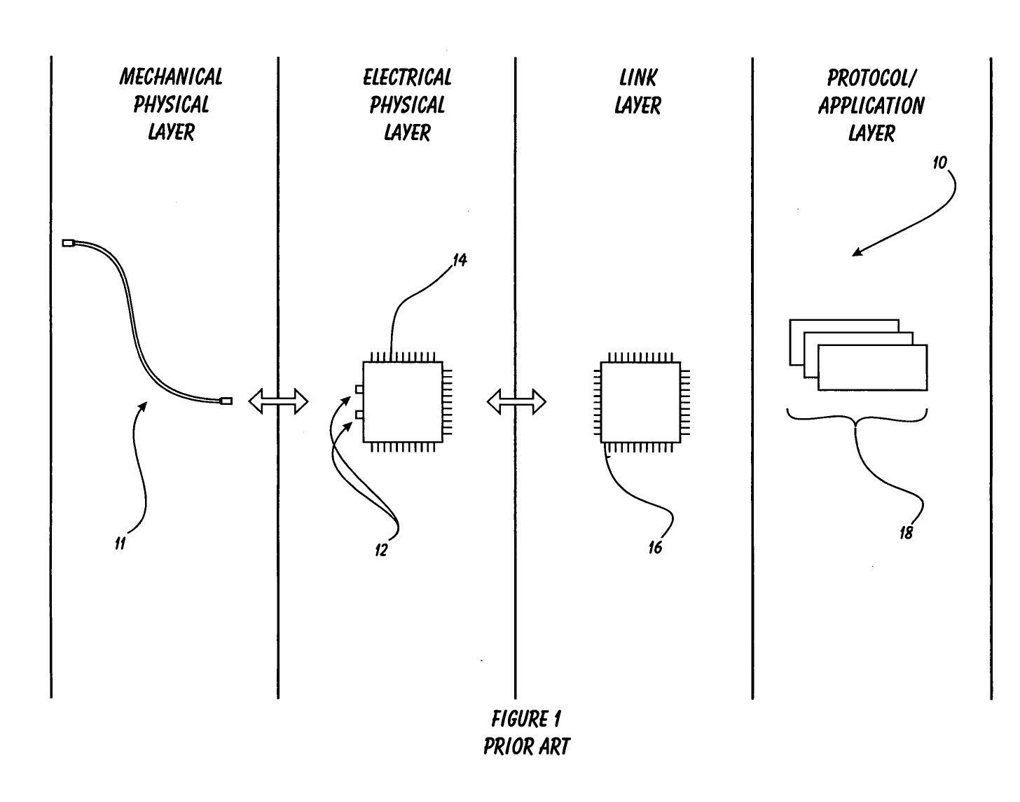

FIG. 2 are flow charts depicting the conventional IEEE 1394A and IEEE 1394B Phy-Link Interface operation;

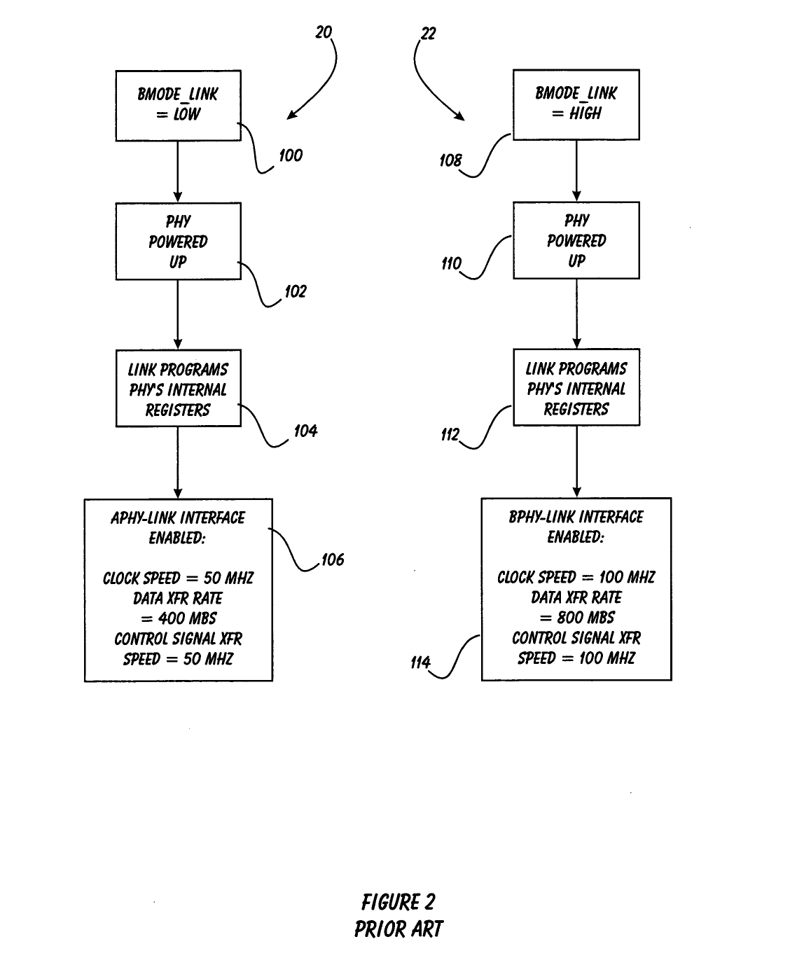

FIG. 3 is a diagram depicting the IEEE 1394 communications protocol layers including the device of the present invention; and

FIG. 4 is a flowchart depicting IEEE 1394A, B and FB Phy-link Interface operation of the present invention.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a High-speed IEEE 1394 Link Interface.

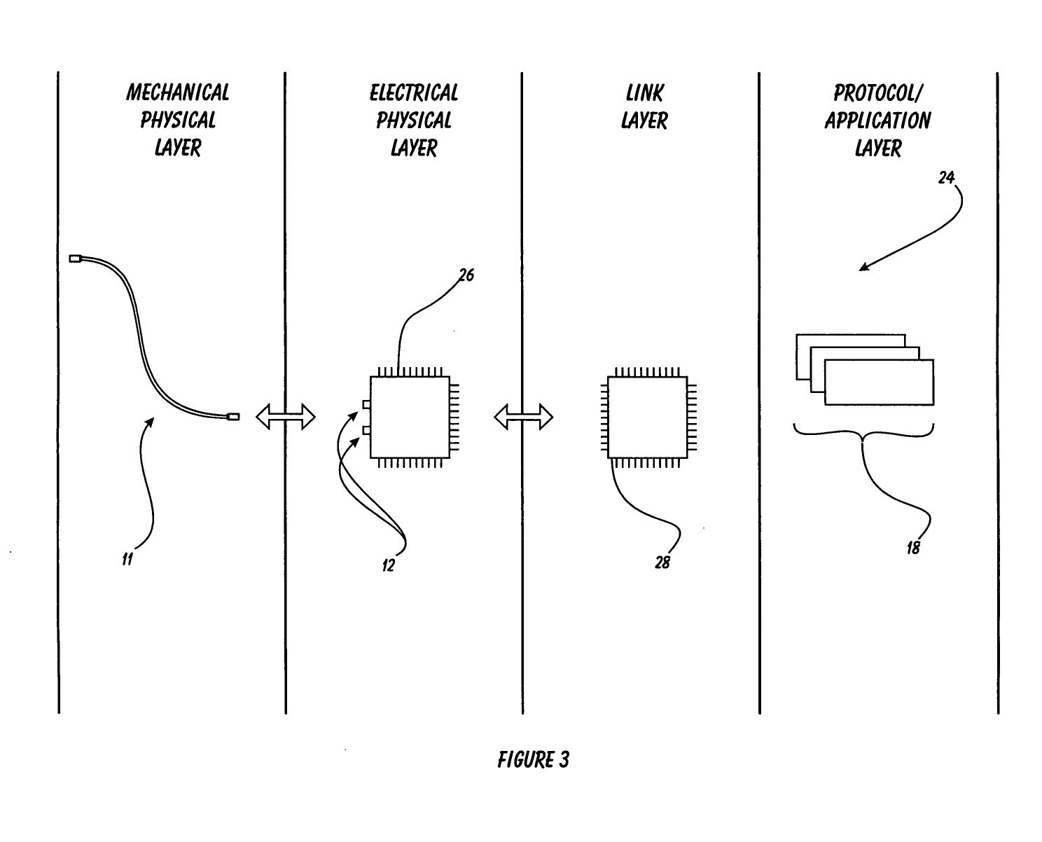

The present invention can best be understood by initial consideration of FIG. 3. FIG. 3 is a diagram 24 depicting the IEEE 1394 communications protocol layers including the device of the present invention. The two distinctions from the prior art are that the conventional phy device is replaced with the A/B/FB Phy device 26 of the present invention. The identification of this device 26 is intended to convey its improved operational attribute, namely, that it can operate in IEEE 1394A and IEEE 1394B modes, but is also configured to operate in a “Fast Beta” mode, which provides a data transfer rate in the Phy-Link Interface that is double that of IEEE 1394B.

The second difference is that the conventional Link device is replaced with (or reconfigured to be) an FBE Link Layer Controller 28. The FBE Link Layer Controller 28 is a Fast Beta Mode enabled, such that in addition to the conventional attributes specified by the IEE1394A/B protocols, it can also activate the A/B/FB Phy Device 26 to operate in Fast Beta Mode (and then can manage the increased data transfer rate). The result of this increased data transfer rate, of course, is to reduce the bottleneck effect that can occur when numerous data transmissions are occurring simultaneously over the Phy-Link Interface.

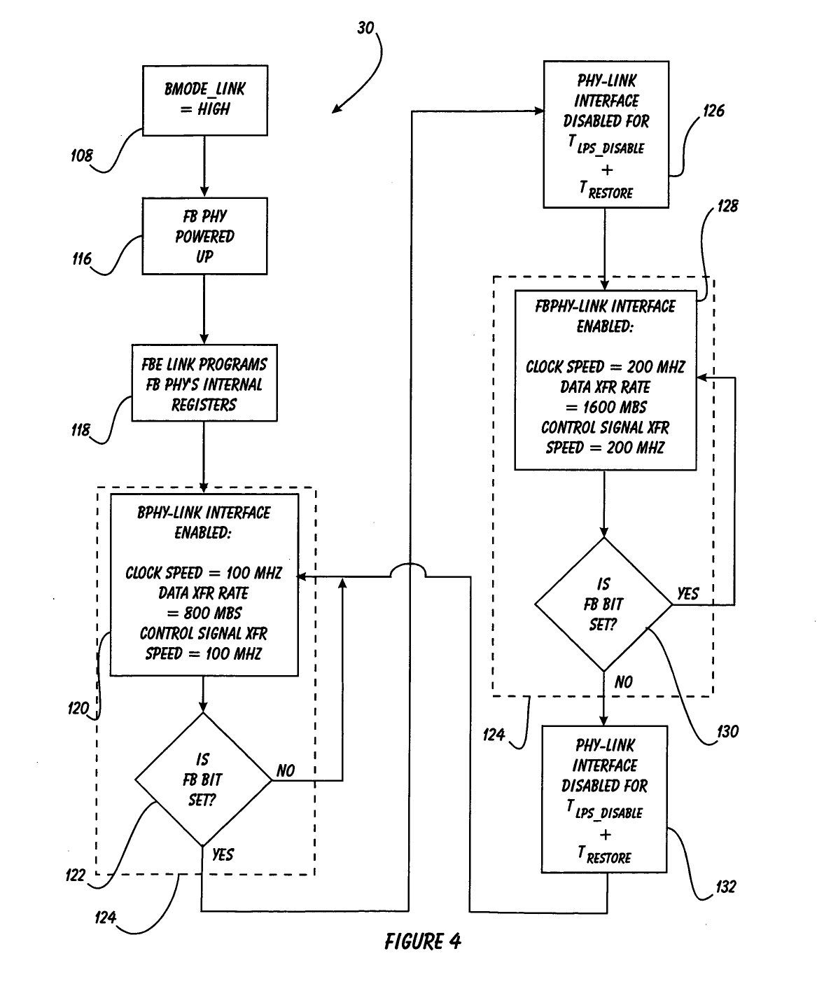

Turning now to FIG. 4, we can examine the pertinent operational distinctions between the prior art and the device and method of the present invention. FIG. 4 is a flowchart depicting IEEE 1394A, B and FB Phy-link Interface operation 30 of the present invention.

The method 30, like the conventional Beta mode, requires that the BMODE_LINK is set to “high.” 108. When the Fast-Beta Phy is powered up 116, and the Fast-Beta-Enabled Link programs the FB Phy's internal registers 118, the initial Phy-Link Interface is enabled in Beta Mode 120, and having the parameters: clock speed of 100 MHz, Data transfer rate of 800 MBS, and Control Signal transfer speed also of 100 MHz.

What is different in this method 30, is that a Fast Beta Bit, which is a part of one of the FB Phy's internal registers, is identified to both the FB Phy and the FBE Link. The FB Phy monitors the status of this bit constantly during normal operation. If the FBE Link sets the FB bit 122, then the Phy-Link Interface will be disabled for a predetermined period of time equal to the sum of T(LPS_DISABLE) and T(RESTORE) 126. The disable period is implemented to prevent data and speed mismatch and other incompatibilities when shifting data transmission speeds.

Upon expiration of the disable period, the Fast Beta Phy-Link Interface is enabled 128. The operational parameters of this interface are that: Clock Speed is 200 MHz, Data Transfer Rate is 1600 MBS, and Control Signal Transfer speed is 200 MHz. As discussed above, this is 2× the transfer rate of a conventional IEEE 1394B Phy-Link Interface.

While in the Fast Beta mode, the FB Phy continues to monitor the FB bit 130. If the FBE Link unsets the FB bit 130, the FB Phy-Link interface will again be disabled for a predetermined period of time equal to the sum of T(LPS_DISABLE) and T(RESTORE) 132.

Upon expiration of the disable period, the conventional Beta Phy-Link Interface will be enabled 120 (actually re-enabled), until such time as the device is powered down or the FB bit is set again 122.

### Technical Specifications of Preferred Embodiments of the Present Invention (SW3161 and SW3168 Devices)

### Pinout (SW3161-64 QFN)

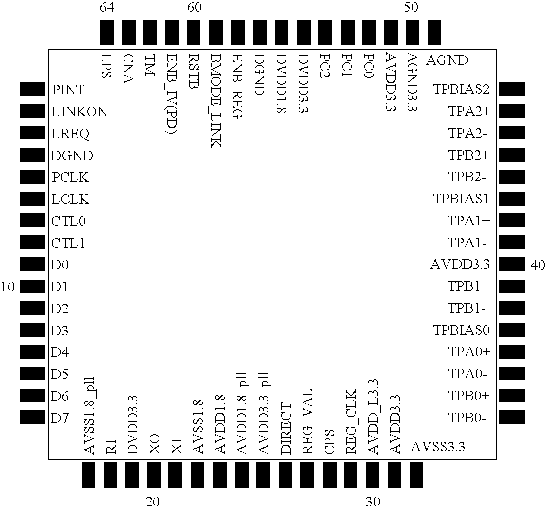

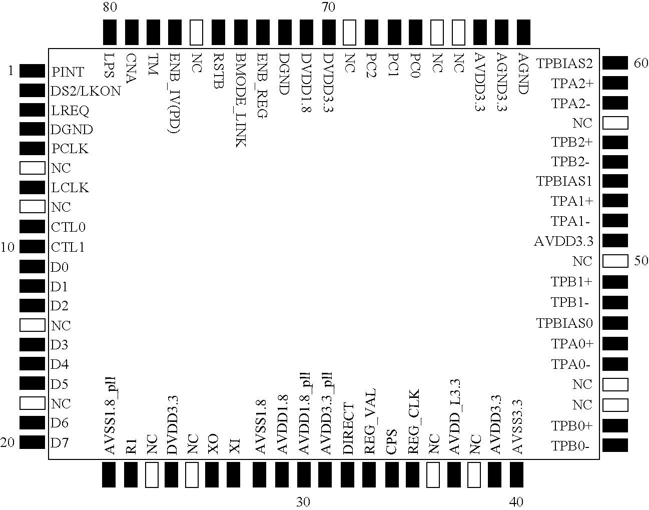

| | SW3161 | SW3168 | | |
|---|---|---|---|---|
| Pin | Pin No | Pin No | I/O/PWR | Description |
| PINT | 1 | 1 | O | PHY Interrupt to LLC |
| LINKON | 2 | 2 | O | Link On notification to LLC |
| LREQ | 3 | 3 | I | Link Request notification from LLC |
| DGND | 4, 57 | 4, 71 | GND | Digital ground |
| PCLK | 5 | 5 | O | PHY Clock used to transfer data and control to |
| | | | | LLC |
| LCLK | 6 | 7 | I | Link Clock used to transfer data and control |
| | | | | from LLC |
| CTL[0:1] | 7, 8 | 9, 10 | I/O | Control to/from LLC |
| D[0:7] | 9, 10, 11 | 11, 12, 13, | I/O | Data to/from LLC |
| | 12, 13, 14, | 15, 16, 17, | | |
| | 15, 16 | 19, 20 | | |
| VSS18_PLL | 17 | 21 | GND | PLL 1.8 V ground |
| R1 | 18 | 22 | | Bias resistance setting |
| DVDD33 | 19, 55 | 24, 70 | PWR | Digital I/O 3.3 V Vdd |
| XTALO | 20 | 26 | O | Crystal output |
| XTALI | 21 | 27 | I | Crystal input |
| AVSS18 | 22 | 28 | GND | Analog 1.8 V ground |
| AVDD18 | 23 | 29 | PWR | Analog1.8 V Vdd |
| AVDD18_PLL | 24 | 30 | PWR | PLL 1.8 V Vdd |
| AVDD33_PLL | 25 | 31 | PWR | PLL 3.3 V Vdd |
| DIRECT | 26 | 32 | I | Direct connection to LLC (no isolation) |
| REG_VAL | 27 | 33 | I | Register input data |
| CPS | 28 | 34 | I | Cable Power Status |
| REG_CLK | 29 | 35 | O | Register input clock |
| AVDD_L33 | 30 | 37 | PWR | Analog 3.3 V Vdd |
| AVDD33 | 31, 40, 51 | 39, 51, 63 | PWR | Analog 3.3 V Vdd |
| AVSS33 | 32, 50 | 31, 50 | GND | Analog 3.3 V ground |
| TPB0− | 33 | 41 | I/O | Port 0 TPB negative differential cable terminal |
| TPB0+ | 34 | 42 | I/O | Port 0 TPB positive differential cable terminal |
| TPA0− | 35 | 45 | I/O | Port 0 TPA negative differential cable terminal |
| TPA0+ | 36 | 46 | I/O | Port 0 TPA positive differential cable terminal |
| TPBIAS0 | 37 | 47 | I/O | Port 0 TPBIAS voltage |
| TPB1− | 38 | 48 | I/O | Port 1 TPB negative differential cable terminal |
| TPB1+ | 39 | 49 | I/O | Port 1 TPB positive differential cable terminal |
| TPA1− | 41 | 52 | I/O | Port 1 TPA negative differential cable terminal |
| TPA1+ | 42 | 53 | I/O | Port 1 TPA positive differential cable terminal |
| TPBIAS1 | 43 | 54 | I/O | Port 1 TPBIAS voltage |
| TPB2− | 44 | 55 | I/O | Port 2 TPB negative differential cable terminal |
| TPB2+ | 45 | 56 | I/O | Port 2 TPB positive differential cable terminal |
| TPA2− | 46 | 58 | I/O | Port 2 TPA negative differential cable terminal |
| TPA2+ | 47 | 59 | I/O | Port 2 TPA positive differential cable terminal |
| TPBIAS2 | 48 | 60 | I/O | Port 2 TPBIAS voltage |
| AGND | 49 | 61 | GND | Analog ground |
| PC[0:2] | 52, 53, 54 | 66, 67, 68 | I | 3-bit power control setting for Self-ID |
| ENB_REG | 58 | 58 | I | 1.8 V Voltage regulator active-low enable |
| BMODE_LINK | 59 | 74 | I | Beta-mode LLC operation enable |
| RSTB | 60 | 75 | I | Active-low PHY reset |
| ENB_IV | 61 | 77 | I | Reference active-low enable |
| TM | 62 | 78 | I | Test mode signal, used for production testing |
| CNA | 63 | 79 | O | Cable not active indication |
| LPS | 64 | 80 | I | Link power status from LLC |
| NC | — | 6, 8, 14, | — | No Connect. No connection is required for |
| | | 18, 23, 25, | | these pins, and any connection made will be |
| | | 36, 38, 43, | | unused. |
| | | 44, 50, 57, | | |
| | | 64, 65, 69, | | |
| | | 76 | | |

Link Interface

The link interface provides a means of connecting an LLC to the Phy for control, access to the serial bus, and access to the Phy's internal registers. The link interface consists of the signals D[7:0], CTL[1:0], PCLK, LCLK, LREQ, PINT, LPS, LKON, BMODE_LINK, and DIRECT. Three modes of link interface operation are supported by the SW3161/SW3168: the IEEE 1394A-2000 standard Legacy Link Interface, the IEEE 1394B-2002 standard Beta Link Interface, and the Inventor's high performance Fast Beta Link Interface. The link interface type is chosen by tying external pins and with internal programmable registers. The choice of which interface to use depends on the type of LLC that is connected to the Phy. Note that the type of LLC that is connected will not necessarily dictate the format or speed of serial bus transceiver actions, i.e. a Phy with a Legacy LLC can still operate in Beta Mode on the serial bus, and a Phy with a 100 MHz Beta Link Interface can still connect to other devices at S1600 speeds.

Link Interface Signals

D[7:0]: bi-directional data from the Phy to LLC or from the LLC to the Phy.
CTL[1:0]: bi-directional control from the Phy to LLC or from the LLC to the Phy. Coding of the CTL signals is dependant on the device that has control of the bus.
PCLK: clock provided by the Phy for timing of the link interface signals.
LCLK: clock returned by the LLC for timing link interface signals when the LLC has control of the bus. Not used in Legacy Link Interface mode.
LREQ: serial interface for the LLC to make requests to the Phy.
PINT: serial interface for the Phy to interrupt the LLC and provide status information. Not used in Legacy Link Mode.
LPS: Link Power Status, enabled when the LLC is powered on.
LKON: used by the Phy to request the LLC to power on and begin link interface.
BMODE_LINK: static signal enabling Beta Mode Link Interface Mode when high.
DIRECT: static signal indicating that the link interface is not differentiated when high.
   200 MHz Link Interface Operation

For S1600 data transferred over the 200 MHz PHY-Link interface, one byte is transferred on each cycle of PClk/LClk, exactly like S800 data over the 100 MHz interface. For speeds below S1600 on the 200 MHz interface, the timing of data (and control) is exactly the same as for the 100 MHz case, meaning that the time that the data is on the control lines does not change, although the number of PClk/LClk cycles that occur while the data is on the lines will double. The same is also true for the Ctl signals. For example, S800 data passed over the 200 MHz bus will look like S400 data passed over the 100 MHz bus, i.e. data is available on the data bus for two cycles of PClk/LClk.

Data Transfer

Data transfer in Fast Beta Mode is exactly the same as with the 100 MHz Beta Mode. However, during the grant cycle the Speed Type of the grant is modified to support S1600 as follows.

### Speed Type During Grant Cycle

| D[5:7] value during | |
|---|---|
| grant cycle | Speed type |
| 000 | S100 |
| 010 | S200 |
| 100 | S400 |
| 110 | S800 |
| 111 | S1600 |

Requests

Requests in Fast Beta Mode are handled exactly the same as with the 100 MHz Beta Mode. However, the speed encoding field on the LREQ serial interface is modified to support S1600 as follows.

### Speed Encoding Values

| Speed Encoding | Speed |
|---|---|
| 0000 | S100 |
| 0001 | Reserved |
| 0010 | S200 |
| 0011 | Reserved |
| 0100 | S400 |
| 0101 | Reserved |
| 0110 | S800 |
| 0111-1110 | Reserved |
| 1111 | S1600 |

Status

Status Transfers in Fast Beta Mode are handled exactly the same as with the 100 MHz Beta Mode, but at twice the speed.

200 MHz Link Interface Timing

Diagram 6.1 illustrates the timing for all PHY-Link interface signals operating at the 200 MHz speed, using the same nomenclature found in the IEEE 1394B specification. Because of the higher speed of the interface, higher performance drivers are required to meet the more stringent timing requirements. It is recommended that devices utilizing the 200 MHz mode take great care in the layout of the PCB to minimize distance between the PHY and link devices, resulting in lower capacitive loading and shorter propagation delay. Applications that require significant physical distance between the PHY and link devices (greater than 10 cm) should not use the 200 MHz mode. Additionally, isolation barriers, such as those suggested by the standard, must not be used, as they will affect the timing margins negatively.

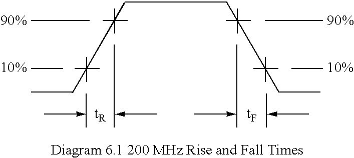

As per the 1394B specification, AC measurements are taken from the 1.575 V level of PClk/LClk to the D, Ctl, or LReq levels, and assume an output load of 10 pF.

TABLE 6.0
AC Timing Parameters

| Name | Description | Minimum | Maximum | Unit |
|---|---|---|---|---|
| | PClk or LClk frequency | 196.608 +/− 100 ppm | | MHz |
| DC_{P} | PClk duty cycle | 45 | 55 | % |
| DC_{L} | LClk duty cycle | DC_{P} − 5 | DC_{P} + 5 | % |
| j_{L} | LClk jitter (pk-pk) | j_{P} + 0.50 | | ns |
| t_{R} | Rise time | — | 2.0 | ns |
| t_{F} | Fall time | — | 2.0 | ns |
| t_{PL} | Delay from rising edge of PClk | | 4.0 | ns |
| | into the link to the rising edge of | | | |
| | LClk from the link | | | |
| t_{SK} | Skew through isolation barrier* | 0 | 0 | ns |
| t_{BR} | Isolation barrier recovery time* | 0 | 0 | ns |
| t_{pdPL} | Signal propagation delay from | | 0.5 | ns |
| | PHY to link | | | |
| t_{pdLP} | Signal propagation delay from link | | 0.5 | ns |
| | to PHY | | | |

*no isolation barrier is allowed for 200 MHZ interface operation

As compared to the 100 MHz spec, the most significant changes above are the duty cycle of PClk/LClk and the rise/fall times. The turn-around time, tPL, through the link is kept as long as possible to accommodate standard IC pad specifications. The signal propagation times are lowered to imply shorter physical distances between the PHY and link.

Transfer waveform timing is described by diagrams 6.2 and 6.3 below, with timing parameters specified in table 6.1.

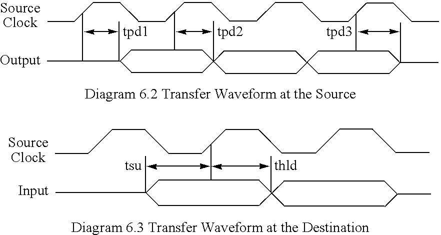

TABLE 6.1
AC Timing Parameters

| Name | Description | Minimum | Maximum | Unit |
|---|---|---|---|---|
| tpd1 | Delay time, | 0.5 | 3.0 | ns |
| | PClk/LClk input high to initial | | | |
| | instance of D[0:n], Ctl[0:1], | | | |
| | PInt/LReq outputs valid | | | |
| tpd2 | Delay time, | 0.5 | 3.0 | ns |
| | PClk/LClk input high to | | | |
| | subsequent instance(s) of D[0:n], | | | |
| | Ctl[0:1], PInt/LReq | | | |
| | outputs valid | | | |
| tpd3 | Delay time, | 0.5 | 3.0 | ns |
| | PClk/LClk input high to | | | |
| | D[0:n], Ctl[0:1] | | | |
| | invalid (high-impedance) | | | |
| tsu | Setup time, | 1.5 | | ns |
| | D[0:n], Ctl[0:1], and PInt/LReq | | | |
| | inputs before PClk/LClk | | | |
| thld | Hold time, | 0.0 | | ns |
| | D[0:n], Ctl[0:1], and PInt/LReq | | | |
| | inputs after PClk/LClk | | | |

The delay times tpd1, tpd2, and tpd3 are significantly shortened to accommodate the higher speed PClk/LClk. Setup time tsu is thereby decreased, and care must be taken with PCB design and IC layout to insure that skew is kept to a minimum.
Registers

The register map for the SW3161/SW3168 Physical Layer IC is divided into six parts, the Common registers, Port 0 registers, Port 1 registers, Port 2 registers, Vendor specific registers, and Vendor ID registers. These registers are specified by and compliant with the register map defined in IEEE 1394B-2002. The Vendor Specific registers are unique to the SW3161/SW3168 devices.

The register map is accessed by the LLC through the use of the LREQ signal and over the serial bus by the Remote Access packet (and by the Phy Configuration packet). Each port has its own register map. To access an individual port register map, the port is first selected by writing to the Port_select field of the Common register map. Addresses 8-15 then correspond to the addresses for the selected port, and may be read or written normally. To access the Vendor Specific registers, a value of 1 must be written to the Page Select register in the Common Registers. Addresses 8-15 will then correspond to the Vendor Specific registers for read and write. Similarly, writing a 7 to the Page Select register will select the Vendor ID registers for Addresses 8-15.

Common

The Common registers control settings and status for the Phy independent of each port and select the Page and Port used for addresses 8-15.

| | Bit | | | | | | | |
|---|---|---|---|---|---|---|---|---|
| Address | 0 | 1 | 2 | 3 | 4 | 5 | 6 | 7 |
| 0000 | Physical_ID | | | | | | R | PS |
| 0001 | RHB | IBR | Gap_count | | | | | |
| 0010 | Extended | | | Total_ports | | | | |
| 0011 | Max_speed | | | Enable_{—} | Delay | | | |
| | | | | Standby | | | | |
| 0100 | Lctrl | Contender | Jitter | | | Pwr_class | | |
| 0101 | Watchdog | ISBR | Loop | Pwr_fail | Timeout | Port_evnt | En_acc | En_multi |

| | | | |
|---|---|---|---|
| 0110 | Max_legacy_path_speed | B_link | Bridge |

| | | |
|---|---|---|
| 0111 | Page select | Port_select |

| Register | Width | Type | Reset | Description |
|---|---|---|---|---|
| Physical_ID | 6 | RU | 0 | The address of this node determined during self- |
| | | | | identification. A value of 63 indicates a |
| | | | | malconfigured bus; the link shall not transmit any |
| | | | | packets. |
| R | 1 | RU | 0 | When set to one, indicates that this node is root |
| PS | 1 | RU | 0 | Cable power status |
| RHB | 1 | RWU | 0 | Root hold-off bit. When one the force_root |
| | | | | variable is TRUE, which instructs the PHY to |
| | | | | attempt to become the root during the next tree-ID |
| | | | | process |
| IBR | 1 | RWU | 0 | Initiate bus reset. When set to one, instructs the |
| | | | | PHY to set ibr TRUE and reset_time to |
| | | | | RESET_TIME. These values in turn cause the |
| | | | | PHY to initiate a bus reset without arbitration; the |
| | | | | reset signal asserted for 166 us. This bit is self- |
| | | | | clearing. Any attempt to set this bit on a nephew |
| | | | | node with a port in standby is ignored. |
| Gap_count | 6 | RWU | 3F | Used to configure the arbitration timer setting in |
| | | | | order to optimize gap times according to the |
| | | | | topology of the bus. |
| Extended | 3 | R | 7 | This field shall have a constant value of seven, |
| | | | | which indicates the extended PHY register map. |
| Total_ports | 5 | R | 3 | This field shall always have a constant value of |
| | | | | three, indicating three ports for this device. |
| Max_speed | 3 | R | 3 | Not used |
| Enable_{—} | 1 | RWU | 0 | Set to enable a port on a candidate nephew node |
| Standby | | | | to go into standby and cleared to prevent a port on |
| | | | | a candidate nephew node from going into |
| | | | | standby. Cleared by the PHY whenever the PHY- |
| | | | | Link interface is enabled. If a nephew has a port |
| | | | | in standby when the PHY clears this bit, then the |
| | | | | port is restored. |
| Delay | 4 | R | * | Worst-case repeater delay, expressed as 144 + delay * 20 ns |
| LCtrl | 1 | RW | 0 | Link active. Cleared or set by software to control |
| | | | | the value of the L bit transmitted in the node's |
| | | | | self-ID packet 0, which shall be the logical AND |
| | | | | of this bit and LPS active. |
| Contender | 1 | RW | 0 | Cleared or set by software to control the value of |
| | | | | the C bit transmitted in the self-ID packet. |
| Jitter | 3 | R | * | The maximum variance of either arbitration or |
| | | | | data repeat delay, expressed as 2 * (Jitter + 1)/ |
| | | | | BASE_RATE us |
| Pwr_class | 3 | RW | 0 | Power class. Controls the value of the pwr field |
| | | | | transmitted in the self-ID packet. |
| Watchdog | 1 | RW | 0 | Watchdog enable Controls whether or not loop, |
| | | | | power fail, and time-out interrupts are indicated to |
| | | | | the link when the PHY-Link interface is not |
| | | | | operational. Also determines whether or not |
| | | | | interrupts are indicated to the link when resume |
| | | | | operations commence for any port (regardless of |
| | | | | the value of Int_enable for the port). |
| ISBR | 1 | RWU | 0 | Initiate short (arbitrated) bus reset. A write of one |
| | | | | to this bit instructs the PHY to set isbr TRUE and |
| | | | | reset_time to SHORT_RESET_TIME. These |
| | | | | values in turn cause the PHY to arbitrate and |
| | | | | issue a short bus reset. This bit is self-clearing. |
| Loop | 1 | RCU | 0 | Loop detect. A write of one to this bit clears it to |
| | | | | zero. |
| Pwr_fail | 1 | RCU | 1 | Cable power failure detect. Set to one when the |
| | | | | PS bit changes from one to zero or upon a PHY |
| | | | | power reset. A write of one to this bit clears it to |
| | | | | zero. |
| Timeout | 1 | RCU | 0 | Arbitration state machine timeout. A write of one |
| | | | | to this bit clears it to zero. |
| Port_event | 1 | RCU | 0 | Port event detect. The PHY sets this bit to one if |
| | | | | any of RX_OK (unless the port is disabled), |
| | | | | Connected, Disabled, Fault, Standby or |
| | | | | Standby_fault change or connection_unreliable |
| | | | | goes TRUE for a port whose Int_enable bit is one. |
| | | | | The PHY also sets this bit to one if resume or |
| | | | | restore operations commence for any port and |
| | | | | Watchdog is one. A write of one to this bit clears |
| | | | | it to zero. |
| En_acc | 1 | RW | 0 | Enable accelerations for DS ports. Used only for |
| | | | | the implementation of Legacy link request |
| | | | | cancellation rules. |
| En_multi | 1 | RW | 0 | If a Legacy link is used, then this bit shall obey |
| | | | | the specification n IEEE 1394A-2000. |
| Max_legacy_{—} | 3 | RU | 0 | Maximum speed observed during bus |
| Path_speed | | | | initialization from self_ID packets transmitted |
| | | | | from or repeated by a Legacy node (i.e. with |
| | | | | either Legacy PHY, link, or both), or S100, |
| | | | | whichever is faster. Encoding is: |
| | | | | 000: S100 |
| | | | | 001: S200 |
| | | | | 010: S400 |
| | | | | all other values: reserved |
| B_link | 1 | RU | 0 | When set to 1, indicates that a B link is connected |
| | | | | to the PHY |
| Bridge | 2 | RW | 0 | This field controls the value of the brdg field in |
| | | | | the self-ID packet. |
| Page_select | 3 | RW | 0 | Selects which of eight possible PHY register |
| | | | | pages are accessible through the window at PHY |
| | | | | register addresses 8-15 |
| Port_select | 4 | RW | 0 | If the page selected by Page_select present per- |
| | | | | port information, this field selects which port's |
| | | | | registers are accessible through the window a |
| | | | | PHY register addresses 8-15. Ports are number |
| | | | | monotonically starting a zero, P0. |

| | Bit | | | | | | | |
|---|---|---|---|---|---|---|---|---|
| Address | 0 | 1 | 2 | 3 | 4 | 5 | 6 | 7 |

| | | | | | | |
|---|---|---|---|---|---|---|
| 0000 | Astat | Bstat | Child | Connected | Receive | Disabled |
| | | | | | OK | |

| | | | | | | |
|---|---|---|---|---|---|---|
| 0001 | Negotiated_speed | Int_enable | Fault | Standby_{—} | Disable_{—} | Beta_mode |
| | | | | Fault | Scrambler | only_port |

| | | | | |
|---|---|---|---|---|
| 0010 | DC_Conn | Max_port_speed | LPP | Cable_speed |
| 0011 | Conn_{—} | | Beta_{—} | |
| | Unreliable | | Mode | |

| 0100 | Port_error | | | |
|---|---|---|---|---|
| 0101 | | Loop | In_{—} | Hard_{—} |
| | | Disable | Standby | Disable |
| 0110 | | | | |
| 0111 | | | | |

| Register | Width | Type | Reset | Description |
|---|---|---|---|---|
| Astat | 2 | RU | 0 | TPA line state for the port (only valid if a DS |
| | | | | port): |
| | | | | 00: invalid |
| | | | | 01: 1 |
| | | | | 10: 0 |
| | | | | 11: Z |
| Bstat | 2 | RU | 0 | TPB line state for the port (only valid if a DS |
| | | | | port). |
| | | | | 00: invalid |
| | | | | 01: 1 |
| | | | | 10: 0 |
| | | | | 11: Z |
| Child | 1 | RU | 0 | If equal to zero, the port is a parent, otherwise it |
| | | | | is a child port (or disconnected or disabled). The |
| | | | | meaning of this bit is undefined from the time a |
| | | | | bus reset is detected until the PHY transitions to |
| | | | | state T1: Child Handshake during the tree |
| | | | | identify process. |
| Connected | 1 | RU | 0 | If equal to one, the port is connected and (Beta |
| | | | | mode only) operating speed negotiation |
| | | | | completed. |
| Receive_ok | 1 | RU | 0 | In DS mode indicates the reception of a |
| | | | | debounced TPBIAS signal. In Beta mode, |
| | | | | indicates the reception of a continuous |
| | | | | electrically valid signal. Note, Receive_ok is set |
| | | | | to false during the time that only connection |
| | | | | tones are detected in Beta mode. |
| Disabled | 1 | RWU | 0 | If equal to one, the port is disabled. |
| Negotiated_{—} | 3 | RU | 0 | Indicates the maximum speed negotiated between |
| Speed | | | | this PHY port and its immediately connected |
| | | | | port; the encoding is as for Max_port_speed. Set |
| | | | | to a speed corresponding to the value of |
| | | | | Port_speed (set on connection when in |
| | | | | Beta_mode, or to value established during Self |
| | | | | ID when in DS mode). |
| Int_enable | 1 | RW | 0 | Enable port event interrupts. When set to one, |
| | | | | the PHY shall set port_event to one if any of this |
| | | | | port's Bias (unless the port is disabled), |
| | | | | Connected, Disabled, Fault, Standby or |
| | | | | Standby_fault bits change state. |
| Fault | 1 | RCU | 0 | Set to one if an error is detected during a suspend |
| | | | | or resume operation, cleared on exit from the |
| | | | | suspend state or (suspend error) the peer port |
| | | | | ceases normal signaling. A write of one to this |
| | | | | bit or receipt of the appropriate remote command |
| | | | | packet shall clear it to zero. When this bit is |
| | | | | zeroed, both resume and suspend errors are |
| | | | | cleared. |
| Standby_{—} | 1 | RCU | 0 | Set to one if an error is detected during a standby |
| Fault | | | | operation and cleared on exit from the standby |
| | | | | state. A write of one to this bit or receipt of the |
| | | | | appropriate remote command packet shall clear it |
| | | | | to zero. When this bit is zeroed, standby errors |
| | | | | are cleared. |
| Disable_{—} | 1 | RW | 0 | When set to one, the port inhibits the operation of |
| Scrambler | | | | the scrambler during transmission of a packet, |
| | | | | such that transmitted scrambled data is equal in |
| | | | | value to unscrambled data. Note that control |
| | | | | states and request types continue to be scrambled. |
| | | | | Intended for use as a test mode only, not used |
| | | | | during normal operation. |
| Beta_mode_{—} | 1 | R | 0 | Always zero - the port is always capable of |
| Only_port | | | | operating in Beta mode. |
| DC_connected | 1 | RU | 0 | If equal to one, the port has detected a DC |
| | | | | connection to the peer port. |
| Max_port_{—} | 3 | RW | 4 | The maximum speed at which a port is allowed to |
| Speed | | | | operate in Beta mode. The encoding is: |
| | | | | 000: S100 |
| | | | | 001: S200 |
| | | | | 010: S400 |
| | | | | 011: S800 |
| | | | | 100: S1600 |
| | | | | 101: S3200 (Not supported) |
| | | | | 110: reserved |
| | | | | 111: DS_mode_only port (port is not capable of |
| | | | | operating in Beta mode) |
| | | | | An attempt to write to the register with a value |
| | | | | greater than the hardware capability of the port |
| | | | | results in the maximum value that the port is |
| | | | | capable of being stored in the register. The port |
| | | | | uses this register only when a new connection is |
| | | | | established in Beta mode. |
| LPP | 1 | RU | 1 | Local Plug Preset (always set to one) |
| Cable_speed | 3 | R | 4 | Set to the maximum possible port speed, S1600. |
| Connection_{—} | 1 | RU | 0 | If one, a Beta mode speed negotiation has failed |
| Unreliable | | | | or synchronization has failed. A write of 1 to this |
| | | | | field resets the value to zero. |
| Beta_mode | 1 | RU | 0 | If equal to one, the port is operating in Beta |
| | | | | mode, equal to zero otherwise (i.e. when |
| | | | | operating in DS mode, or when disconnected). If |
| | | | | Connected is one and Beta_mode is zero, then the |
| | | | | port is operating in DS mode. |
| Port_error | 8 | RCU | 0 | Incremented whenever the port receives an |
| | | | | INVALID codeword, unless the value is already |
| | | | | 255. Cleared when read (including being read by |
| | | | | means of a remote access packet). Intended for |
| | | | | use by a single bus-wide diagnostic program. |
| Loop_disable | 1 | RU | 0 | Set if the port has been placed in the |
| | | | | Loop_disable state as part of the loop free build |
| | | | | process (the PHYs at either end of the connection |
| | | | | are active, but if the connection itself were |
| | | | | activated, then a loop would exist). Cleared on |
| | | | | bus reset and on disconnection. |
| In_standby | 1 | RU | 0 | Set to one if the port is in standby. |
| Hard_disable | 1 | RW | 0 | No effect unless the port is disabled. If equal to |
| | | | | one, the port does not maintain connectivity |
| | | | | status on an AC connection when disabled. The |
| | | | | values of Connected and Receive_OK are forced |
| | | | | to zero. This flag can be used to force |
| | | | | renegotiation of the speed of a connection. |

Operation

Operation of the SW3161/SW3168 begins with powering the 3.3V supply with the active-low reset signal RSTB low. All bidirectional Phy-link interface signals should be high-impedance, and LCLK should be low. The device will then start up its internal 1.8V regulator, which will settle within 1 ms. At this point the Phy is ready for operation, and RSTB can be set high. The Phy will startup its internal PLL, and, depending on the Power Class setting (pins PC[0:2]), it will activate the Phy-link interface by toggling signal LINKON. The LLC should respond by setting signal LPS high (or toggling if the interface is differentiated). If the Power Class is set such that the Phy does not activate the Phy-link interface, the LLC may now enable the interface itself by setting LPS high. After this handshake is complete, the Phy will begin toggling PCLK. If BMODE_LINK is high, signifying that the Phy-link interface should operate in Beta Mode, then PCLK will toggle at 100 MHz and the LLC should send a buffered version of PCLK back on the signal LCLK. If BMODE_LINK is low then the Phy-link interface will operate in Legacy Mode, PCLK will toggle at 50 MHz, and the LLC should hold LCLK low. The Phy will then begin a series of steps to clear the Phy-link interface signal lines and then hand over the control of the interface to the LLC. The LLC must also take steps to clear the signal lines before handing the interface back over to the Phy. This procedure of clearing the signal lines is described in the Link Interface section of this document. At this point the Phy has been initialized, the Phy-link interface is operational, and the LLC may set the Phy configuration for specific applications.

Configuration is done by setting internal Phy registers to their desired value. These registers affect the device as a whole (node level), or on a port-by-port basis. These registers and their effects are described in the Registers section of this document. In order to maintain correct operation, the LLC must issue a soft device reset (by writing to the soft reset register bit) after changing configuration parameters that affect port operation, such as setting the maximum port speed, enabling CAT-5 operation, or setting the Listen Only parameter. Performing a soft device reset has the same effect as bringing RSTB low, except that the Phy-link interface and the internal writeable registers are not reset. In general, it is recommended that the LLC use the following sequence to configure the Phy: program the per-port registers (including vendor specific registers), soft reset, program the node level (device level) registers. The LLC may reset the entire device in exactly the same way as the RSTB signal works by writing to the hard reset register, however this will immediately disable the Phy-link interface and reset all of the configuration parameters. The soft reset and hard reset registers are self-clearing, so they will always read back zero, and it is not necessary to ever write them to zero.

If the LLC is operating in Beta Mode and it wishes to use Fast Beta Mode, it must write a one to the LINK_{—}200 MHZ register and then disable the Phy-link interface. Then the interface is re-enabled, it will operate in Fast Beta Mode. This procedure is described in the Link Interface section of this document.

Individual ports may be disabled with the hard disable register. These ports will not maintain any connectivity with existing connections, and will not attempt to discover any new connections. If a port is not attached to a cable connector in a particular application, this bit should always be set by the LLC to minimize current drain. To disable the entire Phy, the LLC may set the RSTB signal low or set the REG_ENB signal high. If the RSTB signal is used, the internal voltage regulator, as well as the internal voltage reference circuits, will be enabled and ready for immediate operation (the internal PLL will not be running, however). If the REG_ENB signal is used to disable the device, then the regulator, all internal references, and all other circuits will be completely powered down for minimum current drain.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A high-speed IEEE 1394 link interface, comprising:
a speed-selectable electrical physical layer device, said electrical physical layer device operational in three selectable speed modes, alpha, beta and fast beta modes; and
a speed-selecting link layer device in communication with said speed-selectable electrical physical layer device, said link layer device controlling said physical layer device to switch between said beta and said fast beta modes.

2. The interface of claim 1, wherein said fast beta mode consists essentially of a clock speed of about 200 megahertz, a data transfer rate of about 1600 megabits per second, and a control signal transfer speed of about 200 megahertz.

3. The interface of claim 2, wherein said alpha mode consists essentially of a clock speed of about 50 megahertz, a data transfer rate of about 400 megabits per second, and a control signal transfer speed of about 50 megahertz.

4. The interface of claim 3, wherein said beta mode consists essentially of a clock speed of about 100 megahertz, a data transfer rate of about 800 megabits per second, and a control signal transfer speed of about 100 megahertz.

5. The interface of claim 4, wherein said physical layer device switches from said beta mode to said fast beta mode upon detection of a set fast beta bit.

6. The interface of claim 5, wherein said fast beta bit status is controlled by said link layer device.

7. The interface of claim 6, wherein said interface is disabled for a predetermined time period when said physical layer device switches from said beta mode to said fast beta mode.

8. The interface of claim 7, wherein said interface is disabled for a predetermined time period when said physical layer device switches from said fast beta mode to said beta mode.

9. A Phy-Link Interface operational method, said Phy-link interface comprising a speed-selectable electrical physical layer device in communication with a speed-selecting link layer device, the method comprising the steps of:
said link layer device setting a BMODE_LINK parameter to “high”;
powering up said physical layer device;
programming internal registers of said physical layer device with said link layer device;
enabling said phy-link interface in BETA mode; and
said physical layer device continuously monitoring a FASTBETA bit parameter.

10. The method of claim 9, wherein if said FASTBETA bit parameter is detected as “set”, said phy-link interface is disabled for a predetermined data and speed matching period.

11. The method of claim 10, wherein upon expiration of said data and speed matching period, enabling said phy-link interface in FASTBETA mode.

12. The method of claim 11, wherein if said FASTBETA bit parameter is detected as “not set” after said phy-link interface is enabled in said FASTBETA mode, said phy-link interface is second disabled for said predetermined data and speed matching period.

13. The method of claim 12, wherein upon expiration of said data and speed matching period of said second disabling, enabling said phy-link interface in said BETA mode.

14. The method of claim 13, wherein said phy-link interface performance parameters when in said BETA mode consist essentially of a clock speed of about 100 megahertz, a data transfer rate of about 800 megabits per second and a control signal speed of about 100 megahertz.

15. The method of claim 14, wherein said phy-link interface performance parameters when in said FASTBETA mode consist essentially of a clock speed of about 200 megahertz, a data transfer rate of about 1600 megabits per second and a control signal speed of about 200 megahertz.

16. A high-speed IEEE 1394 link interface, comprising:
a speed-selectable electrical physical layer device, said electrical physical layer device operational in three selectable speed modes, alpha, beta and fast beta modes; and
a speed-selecting link layer device in communication with said speed-selectable electrical physical layer device, said link layer device controlling said physical layer device to switch between said beta and said fast beta modes.

17. The interface of claim 16, wherein said fast beta mode is defined by a clock speed of about 200 megahertz, a data transfer rate of about 1600 megabits per second, and a control signal transfer speed of about 200 megahertz.

18. The interface of claim 17, wherein said alpha mode is defined by a clock speed of about 50 megahertz, a data transfer rate of about 400 megabits per second, and a control signal transfer speed of about 50 megahertz.

19. The interface of claim 18, wherein said beta mode is defined by a clock speed of about 100 megahertz, a data transfer rate of about 800 megabits per second, and a control signal transfer speed of about 100 megahertz.

20. The interface of claim 19, wherein said physical layer device switches from said beta mode to said fast beta mode upon detection of a set fast beta bit, said fast beta bit status being controlled by said link layer device.
